(19) United States
(12) Patent Application Publication
(10) Pub. No.: US 2025/0363626 A1
(43) Pub. Date: Nov. 27, 2025

(54) AUTOMATED PRE-MORBID CHARACTERIZATION OF PATIENT ANATOMY USING POINT CLOUDS

(71) Applicant: Howmedica Osteonics Corp., Mahwah, NJ (US)

(72) Inventors: Yannick Morvan, Saint Renan (FR); Jérôme Ogor, Brest (FR); Jean Chaoui, Lyon (FR); Julien Ogor, Brest (FR); Thibaut Nico, Brest (FR)

(21) Appl. No.: 18/872,683

(22) PCT Filed: Jun. 2, 2023
(86) PCT No.: PCT/US2023/024326

§ 371 Date: Dec. 6, 2024

Related U.S. Application Data
(60) Provisional application No. 63/350,732, filed on Jun. 9, 2022.

(51) Int. Cl. G06T 7/00; G06T 7/11; G06V 10/764; G06V 10/82; G06V 20/70

(52) U.S. Cl. CPC G06T 7/0012; G06T 7/11; G06V 10/764; G06V 10/82; G06V 20/70; G06T 2207/10028; G06T 2207/20084; G06T 2207/30008; G06V 2201/033

(57) ABSTRACT

A method for pre-morbid characterization of patient anatomy includes obtaining a first point cloud representing a morbid state of a bone of a patient, generating information indicative of at least one of pathological portions of the first point cloud or non-pathological portions of the first point cloud, the pathological portions of the first point cloud being portions corresponding to pathological portions of the morbid state of the bone, and the non-pathological portions of the first point cloud being portions corresponding to non-pathological portions of the morbid state of the bone, generating a second point cloud that includes points corresponding to the non-pathological portions, and does not include points corresponding to the pathological portions, generating, based on these second point cloud, a third point cloud representing a pre-morbid state of the bone, and outputting information indicative of the third point cloud representing the pre-morbid state of the bone.

This application claims priority to U.S. Provisional Patent Application 63/350,732, filed Jun. 9, 2022, the entire content of which is incorporated by reference.

### BACKGROUND

Surgical joint repair procedures involve repair and/or replacement of a damaged or diseased joint. A surgical joint repair procedure, such as joint arthroplasty as an example, may involve replacing the damaged joint with a prosthetic that is implanted into the patient's bone. Proper selection or design of a prosthetic that is appropriately sized and shaped and proper positioning of that prosthetic are important to ensure an optimal surgical outcome. A surgeon may analyze damaged bone to assist with prosthetic selection, design and/or positioning, as well as surgical steps to prepare bone or tissue to receive or interact with a prosthetic.

### SUMMARY

This disclosure describes example techniques to perform pre-morbid characterization of patient anatomy, such as one or more anatomical objects. Pre-morbid characterization refers to determining a predictor model that predicts characteristics (e.g., size, shape, location) of patient anatomy as the anatomy existed prior to damage to the patient anatomy or disease progression of the anatomy. In examples described in this disclosure, the predictor model may be a point cloud of pre-morbid anatomy of the morbid anatomy (e.g., a pre-morbid state of a bone). Processing circuitry may be configured to further process the point cloud of the pre-morbid anatomy. For instance, the processing circuitry may generate a graphical shape model of the pre-morbid anatomy that a surgeon can view to assist in planning of an orthopedic surgical procedure (e.g., to repair or replace an orthopedic joint).

In one or more examples, processing circuitry may be configured to utilize point cloud neural networks (PCNNs) to generate the point cloud of the pre-morbid anatomy. For instance, the processing circuitry may apply a first PCNN to a point cloud representation of a morbid state of the anatomy to identify pathological (e.g., deformed) and non-pathological (e.g., non-deformed) portions of the morbid state of the anatomy. The pathological portions of the point cloud being portions of the point cloud corresponding to pathological portions of the morbid state of the anatomy, and the non-pathological portions of the point cloud being portions of the point cloud corresponding to non-pathological portions of the morbid state of the anatomy.

The processing circuitry may remove the pathological portions from the point cloud, and then apply a second PCNN to the non-pathological portions to generate the point cloud representing the pre-morbid state of the anatomy (e.g., pre-morbid characterization of the patient anatomy). In this way, the example techniques utilize point cloud processing using neural networks that may improve the accuracy of determining the pre-morbid characterization of patient anatomy.

In one or more examples, it may be not necessary to utilize both the first PCNN and the second PCNN. For instance, the processing circuitry may determine pathological and non-pathological portions of the anatomy in the morbid state using techniques that do not necessarily rely upon a PCNN, such as surgeon input, comparison to point clouds of other similar patients having non-morbid anatomy, a statistical shape model (SSM), etc. In such examples, after removal of the pathological portions, the processing circuitry may utilize a PCNN to generate the point cloud representing the pre-morbid state of the anatomy. As another example, the processing circuitry may apply a PCNN to a first point cloud to identify pathological and non-pathological portions of the anatomy in the morbid state. After removal of the pathological portions, the processing circuitry may generate the point cloud representing the pre-morbid state of the anatomy without necessarily using a PCNN, such as based on surgeon input, comparison to point clouds of other similar patients having non-morbid anatomy, an SSM, etc.

The above examples describe techniques for pre-morbid characterization to assist with surgical planning. The example techniques described in this disclosure are not so limited. In some examples, the processing circuitry may be configured to perform the example techniques described in this disclosure for revision surgery. A patient may have been implanted with a prosthetic. However, at some point in the future, surgery may be needed to address disease progression, shifting of the prosthetic, or because the prosthetic has reached the end of its practical lifetime. The surgery to replace the current prosthetic with another prosthetic is referred to as revision surgery.

In one or more examples, the processing circuitry may obtain a first point cloud representing anatomy of a patient having a prosthetic that was implanted during an initial surgery. The processing circuitry may generate, based on the first point cloud, a second point cloud representing the anatomy of the patient prior to the initial surgery. For example, the processing circuitry may generate the second point cloud by applying a point cloud neural network (PCNN) to the first point cloud. In this example, the PCNN may be trained to generate patient anatomy prior to the initial surgery (e.g., in the diseased or damaged state that led to the surgery). The processing circuitry may output the information indicative of the second point cloud (e.g., that represents the anatomy of the patient prior to the initial surgery).

In one example, this disclosure describes a method for pre-morbid characterization of patient anatomy, the method comprising: obtaining, by a computing system, a first point cloud representing a morbid state of a bone of a patient; generating, by the computing system, information indicative of at least one of pathological portions of the first point cloud or non-pathological portions of the first point cloud, the pathological portions of the first point cloud being portions of the first point cloud corresponding to pathological portions of the morbid state of the bone, and the non-pathological portions of the first point cloud being portions of the first point cloud corresponding to non-pathological portions of the morbid state of the bone; generating, by the computing system, a second point cloud that includes points corresponding to the non-pathological portions of the morbid state of the bone, and does not include points corresponding to the pathological portions of the morbid state of the bone; generating, by the computing system and based on the second point cloud, a third point cloud representing a pre-morbid state of the bone; and outputting, by the computing system, information indicative of the third point cloud representing the pre-morbid state of the bone.

In one example, this disclosure describes a method for pre-surgical characterization of patient anatomy for revision surgery, the method comprising: obtaining, by a computing system, a first point cloud representing a bone of a patient having a prosthetic that was implanted during an initial surgery; generating, by the computing system and based on the first point cloud, a second point cloud representing the bone of the patient at a time of the initial surgery; and outputting, by the computing system, information indicative of the second point cloud.

In one example, this disclosure describes a system comprising: a storage system configured to store a first point cloud representing a morbid state of a bone of a patient; and processing circuitry configured to: obtain the first point cloud representing the morbid state of the bone of the patient; generate information indicative of at least one of pathological portions of the first point cloud or non-pathological portions of the first point cloud, the pathological portions of the first point cloud being portions of the first point cloud corresponding to pathological portions of the morbid state of the bone, and the non-pathological portions of the first point cloud being portions of the first point cloud corresponding to non-pathological portions of the morbid state of the bone, generate a second point cloud that includes points corresponding to the non-pathological portions of the morbid state of the bone, and does not include points corresponding to the pathological portions of the morbid state of the bone; generate, based on the second point cloud, a third point cloud representing a pre-morbid state of the bone; and output information indicative of the third point cloud representing the pre-morbid state of the bone.

In one example, this disclosure describes a system comprising: a storage system configured to store a first point cloud representing a bone of a patient having a prosthetic that was implanted during an initial surgery; and processing circuitry configured to: obtain the first point cloud representing the bone of the patient having the prosthetic that was implanted during the initial surgery, generate, based on the first point cloud, a second point cloud representing the bone of the patient at a time of the initial surgery; and output information indicative of the second point cloud.

In one or more examples, this disclosure describes systems comprising means for performing the methods of this disclosure and computer-readable storage media having instructions stored thereon that, when executed, cause computing systems to perform the methods of this disclosure.

The details of various examples of the disclosure are set forth in the accompanying drawings and the description below. Various features, objects, and advantages will be apparent from the description, drawings, and claims.

### BRIEF DESCRIPTION OF DRAWINGS

FIG. 1A is a block diagram illustrating an example system that may be used to implement the techniques of this disclosure.

FIG. 1B is a block diagram illustrating another example system that may be used to implement the techniques of this disclosure.

FIG. 2 is a block diagram illustrating example components of a planning system, in accordance with one or more techniques of this disclosure.

FIG. 3 is a conceptual diagram illustrating an example point cloud neural network (PCNN), in accordance with one or more techniques of this disclosure.

FIG. 4 is a flowchart illustrating an example architecture of a T-Net model in accordance with one or more techniques of this disclosure.

FIG. 5 is a flowchart illustrating an example process for pre-morbid characterization of patient anatomy in accordance with one or more techniques of this disclosure.

FIG. 6 is a flowchart illustrating an example process for pre-surgical characterization of patient anatomy for revision surgery.

### DETAILED DESCRIPTION

A patient may suffer from a disease (e.g., aliment) that causes damage to the patient anatomy, or the patient may suffer an injury that causes damage to the patient anatomy. To address the disease or injury, a surgeon may perform a surgical procedure. There may be benefits for the surgeon to determine, prior to the surgery, characteristics (e.g., size, shape, and/or location) of the patient anatomy prior to the damage, referred to as pre-morbid characteristics. For instance, determining the pre-morbid characteristics of the patient anatomy may aid in prosthetic selection, design and/or positioning, as well as planning of surgical steps to prepare a surface of the damaged bone to receive or interact with a prosthetic. With advance planning, the surgeon can determine, prior to surgery, rather than during surgery, steps to prepare bone or tissue, tools that will be needed, sizes and shapes of the tools, the sizes and shapes or other characteristics of one or more protheses that will be implanted and the like.

For example, for bone as an example patient anatomy, reconstruction of the bone before the damage (e.g., pre-morbid characteristics of the bone) may be useful for helping the surgeon to fix the damaged bone. For example, a digital reconstruction of the pre-morbid anatomy may help to validate the possible operations needed and validate the functionality of the adjacent joints. As an example, an overlay of the damaged bone and the reconstructed bone (e.g., digital representation of the pre-morbid bone) helps to identify which tools are necessary.

As described above, pre-morbid characterization refers to characterizing the patient anatomy as it existed prior to the patient suffering disease or injury. However, pre-morbid characterization of the anatomy is generally not available because the patient may not consult with a doctor or surgeon until after suffering the disease or injury.

Pre-morbid anatomy, also called native anatomy, refers to the anatomy prior to the onset of a disease or the occurrence of an injury. Even after disease or injury, there may be portions of the anatomy that are healthy and portions of the anatomy that are not healthy (e.g., diseased or damaged). The diseased or damaged portions of the anatomy are referred to as pathological anatomy, and the healthy portions of the anatomy are referred to as non-pathological anatomy.

This disclosure describes example techniques to determine a representation of a pre-morbid state of the anatomy (e.g., a predictor of the pre-morbid anatomy) using point cloud processing, such as, point cloud neural networks (PCNNs). A PCNN is implemented using a point cloud learning model-based architecture. A point cloud learning model-based architecture (e.g., a point cloud learning model) is a neural network-based architecture that receives one or more point clouds as input and generates one or more point clouds as output. Example point cloud learning models include PointNet, PointTransformer, and so on.

In one or more examples described in this disclosure, processing circuitry may be configured to determine (e.g., obtain) a first point cloud that represents a morbid state of patient anatomy (e.g., damaged or diseased patient anatomy). For instance, the processing circuitry may receive one or more images of the patient anatomy in the morbid state, and determine the first point cloud based on the received one or more images.

This disclosure describes the processing circuitry obtaining the first point cloud. The processing circuitry may receive one or more images of the patient anatomy in the morbid state, and determine the first point cloud based on the received one or more images, as one example of obtaining the first point cloud. As another example, some other circuitry may generate the first point cloud, and the processing circuitry may receive the generated first point cloud to obtain the first point cloud.

The processing circuitry may generate information indicative of at least one of pathological portions of the first point cloud or non-pathological portions of the first point cloud. The pathological portions of the first point cloud being portions of the first point cloud corresponding to pathological portions of the morbid state of the anatomy, and the non-pathological portions of the first point cloud being portions of the first point cloud corresponding to non-pathological portions of the morbid state of the anatomy. As one example, the processing circuitry may generate information indicative of at least one of the pathological portions or the non-pathological portions of the first point cloud based on applying a point cloud neural network (PCNN) to the first point cloud. In this example, the PCNN may be trained to identify at least one of the pathological portions or the non-pathological portions.

For instance, during training, the PCNN may receive, as input, point clouds representing a morbid state of various bones, and may also receive, as input, information identifying pathological portions and non-pathological portions on the input point clouds. As an example, a surgeon may provide the information of pathological portions and non-pathological portions that form ground truths for the input point clouds representing a morbid state of various bones. Processing circuitry for training the PCNN may be configured to determine weights and other factors that, when applied to the input point clouds, generate information indicative pathological and non-pathological portions that align with the determination made by the surgeon. The result of the training may be a trained PCNN that the processing circuitry may apply to the first point cloud to generate information indicative of at least one of the pathological portions or the non-pathological portions of the first point cloud.

The use of a PCNN for determining pathological and non-pathological portions is not necessary in all examples. In some examples, the processing circuitry may utilize other techniques such as receiving surgeon input, comparison to similar patients having non-morbid anatomy, utilizing a statical shape model (SSM), etc., for determining pathological and non-pathological portions.

For example, for an SSM, the processing circuitry may obtain a point cloud of the SSM, where the SSM is a representative model of a pre-morbid state the anatomy. The processing circuitry may orient the point cloud of the SSM or the point cloud representing the morbid state of the anatomy so that the point cloud of the SSM and the point cloud representing the morbid state of the anatomy have the same orientation. The processing circuitry may determine non-pathological points in the point cloud representing the morbid state of the anatomy. For instance, as described above, in the point cloud representing the morbid state of the anatomy, there may be pathological portions and non-pathological portions. The processing circuitry may identify one or more points in the non-pathological portions (referred to as non-pathological points). The non-pathological points to identify in the point cloud representing the morbid state of the anatomy may be pre-defined based on the cause of the morbidity (e.g., there may be certain portions of the anatomy that are known to not be impacted by a disease). The processing circuitry may deform the point cloud of the SSM until the points in the point cloud of the SSM register with the identified non-pathological points. The processing circuitry may determine a difference between the registered SSM and the point cloud representing the morbid state of the anatomy. The result of the difference may be the pathological portions.

Although the SSM may be used to determine a pre-morbid state of the anatomy, the use of the SSM may not be as accurate as desired. However, the use of SSM for identifying pathological portions and non-pathological portions in the point cloud representing the morbid state of the anatomy may be of sufficient accuracy.

The processing circuitry may be configured to generate a second point cloud that includes points corresponding to the non-pathological portions of the morbid state of the anatomy, and does not include points corresponding to the pathological portions of the morbid state of the anatomy. For instance, the processing circuitry may be configured to remove the portions of the first point cloud that represent deformed anatomy to generate a second point cloud. That is, the processing circuitry may generate a second point cloud having the pathological portions removed, such that the second point cloud includes points corresponding to the non-pathological portions, and does not include points corresponding the pathological portions. In such examples, the second point cloud may be the first point cloud with the portions including deformed anatomy (e.g., pathological portions) removed, so that the non-deformed anatomy (e.g., non-pathological portions) remains.

In accordance with one or more examples described in this disclosure, the processing circuitry may be configured to generate, based on the second point cloud, a third point cloud representing a pre-morbid state of the morbid anatomy (e.g., a pre-morbid state of the bone). There may be various example ways in which to generate, based on the second point cloud, the third cloud representing a pre-morbid state of the anatomy. As one example, the processing circuitry may generate the third point cloud by applying a PCNN to the second point cloud. For instance, the PCNN may be trained to reconstruct pre-morbid anatomy from a point cloud of non-pathological portions of the anatomy.

As an example, during training, the PCNN may receive as input point clouds representing non-pathological portions of various bones (e.g., incomplete point clouds of a healthy bone), and may also receive as input point clouds of the healthy bones. For instance, for a point cloud of a healthy bone, during training, the processing circuitry or a user may remove N % of the points from the point cloud, and possibly from different regions of the point cloud. The remaining portions of the bone may be considered as a non-pathological portion. The processing circuitry may receive both the point cloud for the non-pathological portion and the point cloud for the healthy bone.

For training the PCNN, the processing circuitry may be configured to determine weights and other factors that, when applied to the input point clouds having the non-pathological portion, generate point clouds that align with the point clouds of the healthy bone. The result of the training may be a trained PCNN that the processing circuitry may apply to the second point cloud to generate a third point cloud representing a pre-morbid state of the anatomy.

As another example, the processing circuitry may determine a non-pathological estimation of the pathological portions of the morbid state of the anatomy. The non-pathological estimation may be considered as an estimation of what the pathological portions of the first cloud point were prior to damage. The processing circuitry may combine the non-pathological estimation of the pathological portions and the second point cloud to generate the third point cloud. For instance, to combine the non-pathological estimation of the pathological portions and the second point cloud, the processing circuitry may fill in the second point cloud with the non-pathological estimation of the pathological portions.

For example, a PCNN may be trained to determine a non-pathological estimation of the pathological portions of the morbid state of the anatomy. For instance, for training, similar to above, the PCNN may receive point clouds representing non-pathological portions of various bones and healthy bones. In such examples, the PCNN may be trained to use points in the non-pathological portion to generate an estimation of the non-pathological portion of the bone (e.g., what the pathological portion would have looked like before the disease or trauma). The processing circuitry may combine the second point cloud with the non-pathological estimation of the pathological portions to generate the third point cloud representing a pre-morbid state of the bone. For instance, the PCNN may be trained to fill in the pathological portion of the bone with an estimation of the non-pathological portion of the bone, so as to complete the pre-morbid representation of the bone.

The non-pathological estimation of the pathological portions refers to an estimation of non-pathological anatomy (e.g., bone) that would fill in the removed pathological portion to result in the pre-morbid state of the anatomy. For instance, the non-pathological estimation of the pathological portions removed from the first point cloud to generate the second point cloud completes the second point cloud so that there are no longer gaps in the second point cloud from the removal of the pathological portions. In one or more examples, the non-pathological estimation is referred to as an “estimation” because the PCNN may be configured to fill in the removed pathological portions with what the PCNN determined as being a representation of the pathological portion, but with non-pathological anatomy (e.g., non-pathological bone).

In the above examples, the processing circuitry may use a PCNN for determining pathological portions and/or non-pathological portions in a first point cloud for generating a second point cloud that includes the pathological portions, and does not include the pathological portions, or use a PCNN on the second point cloud to generate a third point cloud representing a pre-morbid sate of the anatomy (e.g., bone). However, in some examples, the processing circuitry may utilize two PCNNs: one for determining the pathological portions and/or non-pathological portions in the first point cloud for generating a second point cloud that includes the pathological portions, and does not include the pathological portions, and another for generating, based on the second point cloud, a third point cloud representing a pre-morbid state of the anatomy. For example, the processing circuitry may generate information indicative of at least one of the pathological portions or the non-pathological portions in the first point cloud by applying a first PCNN to the first point cloud, where the first PCNN is trained to identify at least one of the pathological portions or the non-pathological portions. The processing circuitry may generate, based on the second point cloud, the third point cloud representing the pre-morbid state of the anatomy by applying a second PCNN to the second point cloud.

The above examples described using a PCNN to generate a third point cloud representing the pre-morbid state of the bone. However, the example techniques are not so limited. In some examples, the processing circuitry may utilize SSM, or some other technique, to generate the third point cloud representing the pre-morbid state of the bone. For instance, the processing circuitry may utilize a PCNN to identify at least one of the pathological portions or the non-pathological portions, and then remove the pathological portions. The processing circuitry may utilize non-pathological portions to drive the fitting of an SSM represented in point cloud. For instance, the processing circuitry may deform the point cloud of the SSM (e.g., stretch, shrink, rotate, translate, etc.) until the points in the point cloud of the SSM register with the identified non-pathological points. The deformed point cloud of the SSM that registers with the identified non-pathological points may be third point cloud representing the pre-morbid state of the bone.

The processing circuitry may output information indicative of the point cloud of the pre-morbid state of the anatomy (e.g., bone). In some examples, the processing circuitry may further process the third point cloud of the pre-morbid anatomy to generate graphical representation of the pre-morbid anatomy or other information, such as dimensions, that a surgeon can utilize for pre-operative planning or utilize during surgery. For example, the surgeon may use the graphical representation to plan which tools to use, where to cut, etc., prior to the surgery. The graphical representation of the pre-morbid anatomy may allow the surgeon to determine which prosthetic to use and how to perform the implant surgery so that the result of the surgery is that the patient's experience (e.g., in ability of movement) is similar to before the patient experienced injury or disease. In some examples, during surgery, the surgeon may wear augmented reality (AR) goggles that provide an overlay of the graphical representation of the pre-morbid anatomy over the morbid anatomy during surgery to help the surgeon ensure that the prothesis approximates the pre-morbid anatomy.

The above describes example techniques for pre-morbid characterization of pre-morbid anatomy. However, the example techniques are not so limited. In some examples, the processing circuitry may be configured to perform the example techniques described in this disclosure for revision surgery. A surgeon may perform an initial surgery to implant a prosthetic. Overtime, the efficacy of the prosthetic may decrease. For instance, as disease progresses, as the prosthetic may shift, or as the practical lifetime of the prosthetic is near its end, the effectiveness of the prosthetic may decrease.

In such cases, the surgeon may determine that a revision surgery is appropriate. In the revision surgery, the surgeon removes the current prosthetic, and implants another prosthetic that may be better tailored to the current state of the patient. When planning and performing the revision surgery, the surgeon may consider it desirable to determine the size and shape of the anatomy at a time the initial surgery was made. That is, the surgeon may desire to determine what the anatomy was like that caused the initial surgery. In some examples, but not necessary all examples, the surgeon may be interested in characterization (e.g., size and shape) of the anatomy at the time of the initial surgery, and may not be as interested in the pre-morbid shape.

There may be various reasons why the surgeon may consider it desirable to determine the characterization of the anatomy at the time of the initial surgery. As one example, after surgery, ligaments and other joint structures may have changed. For instance, the ligaments may have tightened. If the revision surgery attempts to reconstruct the damaged anatomy back to the pre-morbid state, there may be a negative impact on the ligaments and other joints that have changed. Therefore, it may be desirable to determine the size and shape of the anatomy at the time of the initial surgery, and for the surgeon to plan the surgery accordingly.

In one or more examples, for pre-surgical characterization of patient anatomy (e.g., characterization before initial surgery) for revision surgery, the processing circuitry may obtain a first point cloud representing anatomy of a patient having a prosthetic that was implanted during an initial surgery. The processing circuitry may generate a second point cloud representing the anatomy of the patient at a time of the initial surgery. For example, the processing circuitry may generate the second cloud by applying a PCNN to the first point cloud. The processing circuitry may output information indicative of the second point cloud.

For instance, for training, the processing circuitry for training the PCNN may receive, as input, point clouds of various bones having protheses currently implanted and point clouds of the same bones at the time the prosthetic was implanted. The processing circuitry may determine weights and other factors that when applied to the input point clouds of various bones having protheses generate point clouds that align with point clouds of the same bones at the time the prosthetic was implanted. The result may be a trained PCNN that outputs a second point cloud representing the bone at the time the prosthetic was implanted based on an input first point cloud of the bone having the implant.

Utilizing a PCNN for revision surgery may be beneficial for various reasons. As one example, at the time of the initial surgery, the surgeon may not have requested a representation of the anatomy in its morbid state (e.g., diseased or damaged state that lead to the initial surgery). In some cases, even if the surgeon requested a representation of the anatomy in its morbid state, the representation may become lost. With the example techniques described in this disclosure, the processing circuitry may be configured to determine the pre-surgical characterization of anatomy even where such pre-surgical characterization information is unavailable.

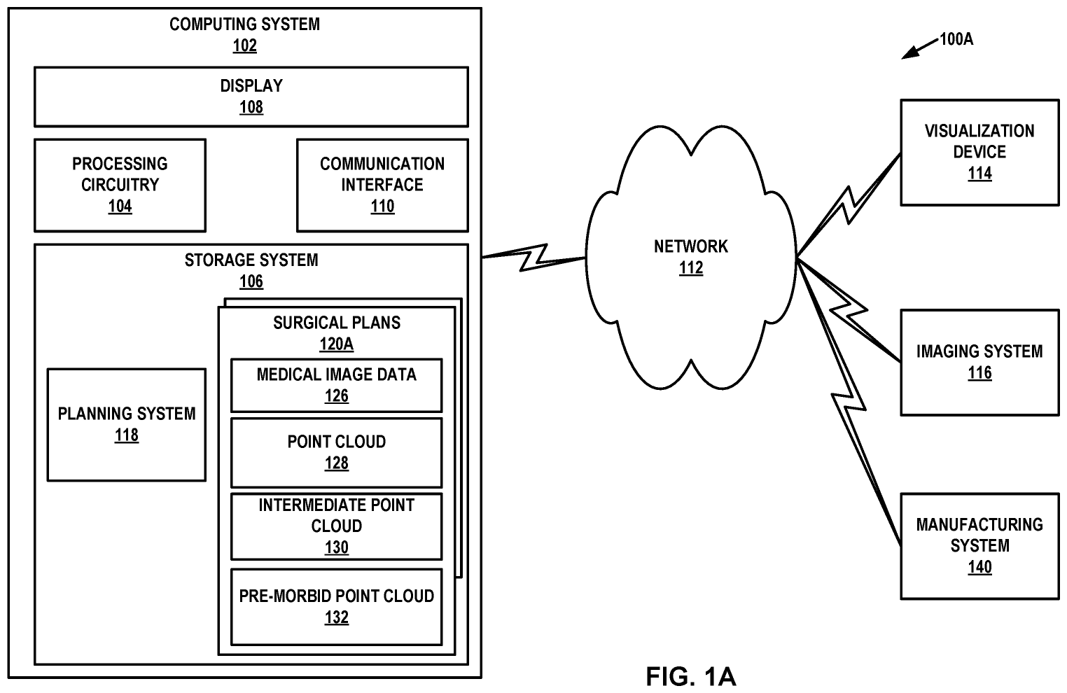

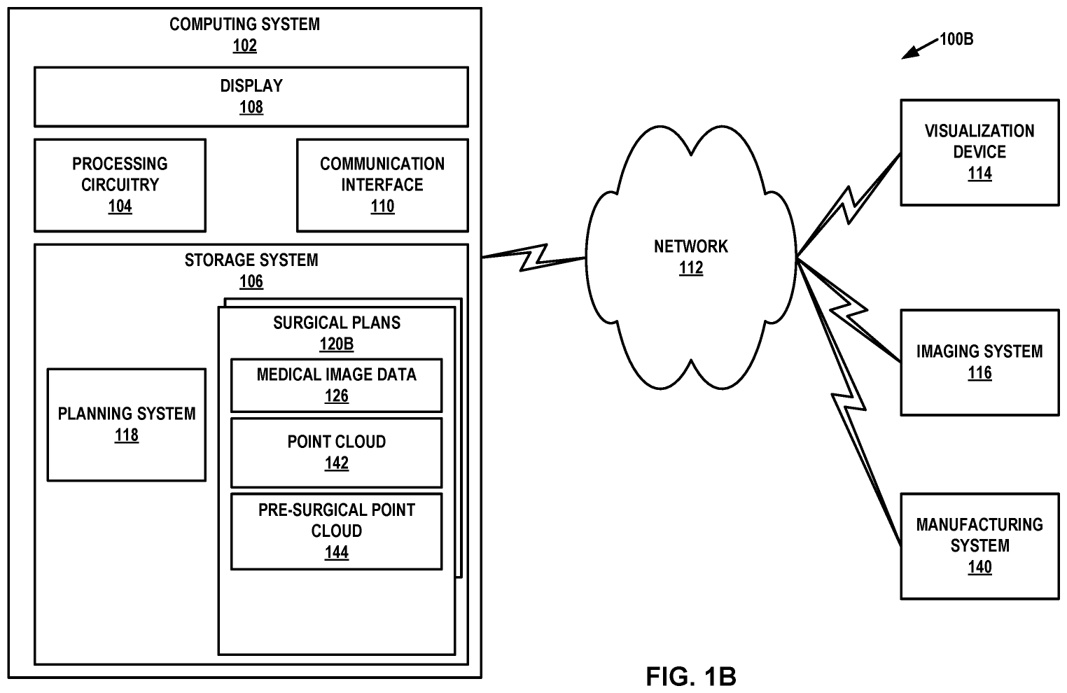

FIG. 1A is a block diagram illustrating an example system 100A that may be used to implement the techniques of this disclosure. FIG. 1A illustrates computing system 102, which is an example of one or more computing devices that are configured to perform one or more example techniques described in this disclosure. Computing system 102 may include various types of computing devices, such as server computers, personal computers, smartphones, laptop computers, and other types of computing devices. In some examples, computing system 102 includes multiple computing devices that communicate with each other. In other examples, computing system 102 includes only a single computing device. Computing system 102 includes processing circuitry 104, storage system 106, a display 108, and a communication interface 110. Display 108 is optional, such as in examples where computing system 102 is a server computer.

Examples of processing circuitry 104 include one or more microprocessors, digital signal processors (DSPs), application specific integrated circuits (ASICs), field programmable gate arrays (FPGAs), discrete logic, software, hardware, firmware or any combinations thereof. In general, processing circuitry 104 may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits. In some examples, processing circuitry 104 is dispersed among a plurality of computing devices in computing system 102 and visualization device 114. In some examples, processing circuitry 104 is contained within a single computing device of computing system 102.

Processing circuitry 104 may include arithmetic logic units (ALUs), elementary function units (EFUs), digital circuits, analog circuits, and/or programmable cores, formed from programmable circuits. In examples where the operations of processing circuitry 104 are performed using software executed by the programmable circuits, storage system 106 may store the object code of the software that processing circuitry 104 receives and executes, or another memory within processing circuitry 104 (not shown) may store such instructions. Examples of the software include software designed for surgical planning.

Storage system 106 may be formed by any of a variety of memory devices, such as dynamic random access memory (DRAM), including synchronous DRAM (SDRAM), magnetoresistive RAM (MRAM), resistive RAM (RRAM), or other types of memory devices. Examples of display 108 include a liquid crystal display (LCD), a plasma display, an organic light emitting diode (OLED) display, or another type of display device. In some examples, storage system 106 may include multiple separate memory devices, such as multiple disk drives, memory modules, etc., that may be dispersed among multiple computing devices or contained within the same computing device.

Communication interface 110 allows computing system 102 to communicate with other devices via network 112. For example, computing system 102 may output medical images, images of segmentation masks, and other information for display. Communication interface 110 may include hardware circuitry that enables computing system 102 to communicate (e.g., wirelessly or using wires) to other computing systems and devices, such as a visualization device 114 and an imaging system 116. Network 112 may include various types of communication networks including one or more wide-area networks, such as the Internet, local area networks, and so on. In some examples, network 112 may include wired and/or wireless communication links.

Visualization device 114 may utilize various visualization techniques to display image content to a surgeon. In some examples, visualization device 114 is a computer monitor or display screen. In some examples, visualization device 114 may be a mixed reality (MR) visualization device, virtual reality (VR) visualization device, holographic projector, or other device for presenting extended reality (XR) visualizations. For instance, in some examples, visualization device 114 may be a Microsoft HOLOLENS™ headset, available from Microsoft Corporation, of Redmond, Washington, USA, or a similar device, such as, for example, a similar MR visualization device that includes waveguides. The HOLOLENS™ device can be used to present 3D virtual objects via holographic lenses, or waveguides, while permitting a user to view actual objects in a real-world scene, i.e., in a real-world environment, through the holographic lenses. In some examples, there may be multiple visualization devices for multiple users.

Visualization device 114 may utilize visualization tools that are available to utilize patient image data to generate three-dimensional models of bone contours, segmentation masks, or other data to facilitate preoperative planning. These tools may allow surgeons to design and/or select surgical guides and implant components that closely match the patient's anatomy. These tools can improve surgical outcomes by customizing a surgical plan for each patient. An example of such a visualization tool is the BLUEPRINT™ system available from Stryker Corp. The surgeon can use the BLUEPRINT™ system to select, design or modify appropriate implant components, determine how best to position and orient the implant components and how to shape the surface of the bone to receive the components, and design, select or modify surgical guide tool(s) or instruments to carry out the surgical plan. The information generated by the BLUEPRINT™ system may be compiled in a preoperative surgical plan for the patient that is stored in a database at an appropriate location, such as storage system 106, where the preoperative surgical plan can be accessed by the surgeon or other care provider, including before and during the actual surgery.

Imaging system 116 may comprise one or more devices configured to generate medical image data. For example, imaging system 116 may include a device for generating CT images. In some examples, imaging system 116 may include a device for generating MRI images. Furthermore, in some examples, imaging system 116 may include one or more computing devices configured to process data from imaging devices in order to generate medical image data. For example, the medical image data may include a 3D image of one or more bones of a patient. In this example, imaging system 116 may include one or more computing devices configured to generate the 3D image based on CT images or MRI images.

Computing system 102 may obtain a point cloud representing one or more patient anatomy (e.g., bones) of a patient. The point cloud may be generated based on the medical image data generated by imaging system 116. In some examples, imaging system 116 may include one or more computing devices configured to generate the point cloud. Imaging system 116 or computing system 102 may generate the point cloud by identifying the surfaces of the one or more bones in images and sampling points on the identified surfaces. Each point in the point cloud may correspond to a set of 3D coordinates of a point on a surface of a bone of the patient. In other examples, computing system 102 may include one or more computing devices configured to generate the medical image data based on data from devices in imaging system 116.

Storage system 106 of computing system 102 may store instructions that, when executed by processing circuitry 104, cause computing system 102 to perform various activities. For instance, in the example of FIG. 1A, storage system 106 may store instructions that, when executed by processing circuitry 104, cause computing system 102 to perform activities associated with a planning system 118. For ease of explanation, rather than discussing computing system 102 performing activities when processing circuitry 104 executes instructions, this disclosure may simply refer to planning system 118 or components thereof as performing the activities or may directly describe computing system 102 as performing the activities.

In the example of FIG. 1A, storage system 106 stores surgical plans 120A. Surgical plans 120A may correspond to individual patients. A surgical plan corresponding to a patient may include data associated with a planned or completed orthopedic surgery on the corresponding patient. A surgical plan corresponding to a patient may include medical image data 126 for the patient, point cloud 128, point cloud 128, intermediate point cloud 130, pre-morbid point cloud 132, and in some examples, tool data (e.g., types of tools needed for the surgery) for the patient. Medical image data 126 may include computed tomography (CT) images of patient anatomy, such as bones of the patient, or 3D images of the patient anatomy based on CT images.

The example techniques in this disclosure are described with respect to a bone being an example of patient anatomy. However, the example techniques should not be considered as limited to bones. In this disclosure, the term “bone” may refer to a whole bone or a bone fragment. Examples of bones include a tibia, a fibula, scapula and humeral head (e.g., shoulder), femur, a patella (e.g., knee), vertebra, or iliac crest, ilium, ischial spine, coccyx (e.g., a hip), etc.

In some examples, medical image data 126 may include magnetic resonance imaging (MRI) images of one or more bones of the patient or 3D images based on MRI images of the one or more bones of the patient. In some examples, medical image data 126 may include ultrasound images of one or more bones of the patient. Point cloud 128 may include point clouds representing bones of the patient. In some examples, the tool alignment data associated with the surgical plains 120A may include data representing one or more tool alignment for use in a surgery.

Planning system 118 may be configured to generate a pre-morbid characterization of a damaged or diseased patient anatomy (e.g., bone). For example, a patient may suffer from a disease, such as osteoarthritis, that can damage the bone due to wearing down of the joints between bones. As another example, a patient may suffer from a trauma, such as fracturing a bone.

A bone that is impacted by disease or trauma is referred to as a morbid bone (e.g., damaged bone). A surgeon performs surgery to correct the damaged bone, such as by implanting prothesis, or other surgeries that can assist in the patient returning to a state before the damage to the bone. To perform the surgery, the surgeon may prepare one of surgical plans 120A. One component of the surgical plan may be information indicative of the characteristics of the morbid bone prior to the damage. A surgeon may utilize such information of the morbid bone prior to the damage for surgical planning (e.g., tool selection, prosthetic selection, manner in which to perform the surgery, etc.) or as part of the surgery (e.g., by viewing an overlay of the bone prior to damage over the damaged bone using an AR headset like visualization device 114).

For instance, point cloud 128 may be point cloud representing a morbid sate of a bone of a patient. Point cloud 128 may be referred to as morbid point cloud 128, or first point cloud 128, to indicate that point cloud 128 represents the morbid state of the bone of the patient. In accordance with one or more techniques of this disclosure, planning system 118 may be configured to generate information indicative of at least one of pathological portions or non-pathological portions in the first point cloud, as described in more detail. Although point cloud 128 represents the morbid state of the bone, not all of the bone may be damaged. For instance, on the bone, there may be bony parts that are not deformed (e.g., non-pathological), and bony parts that are deformed (e.g., pathological).

In some examples, point cloud 128 need not include the entire bone. As one example, for ankle fractures, the distal end, near the ankle, of the tibia tends to always be damaged. In one or more examples, planning system 118 may assume that the distal end of the tibia is damaged, and not include that distal end of the tibia as part of the determining pathological portions and non-pathological portions because it is assumed that the distal end of the tibia is a pathological portion. Accordingly, in some examples, point cloud 128 representing the morbid state of the bone of the patient may be a point cloud of a morbid tibia, where a distal end, near an ankle, of the tibia is removed from the point cloud of the tibia. In such examples, to generate information indicative of at least one of pathological portions or non-pathological portions in point cloud 128, planning system 118 may generate information indicative of at least one of pathological portions or non-pathological portions in point cloud 128 of the tibia having the distal end removed.

Planning system 118 may be configured to identify, in point cloud 128, which portions of a bone are pathological and which portions of the bone are non-pathological. The pathological portions of the first point cloud may be portions of the first point cloud corresponding to pathological portions of the morbid state of the bone, and the non-pathological portions of the first point cloud may be portions of the first point cloud corresponding to non-pathological portions of the morbid state of the bone.

That is, if planning system 118 only identifies pathological portions of the bone, then the other portions may be considered as being non-pathological, and vice-versa. It may be possible for planning system 118 to identify both pathological portions of the bone and non-pathological portions of the bone.

Planning system may generate intermediate point cloud 130, also referred to as a second point cloud 130, that includes points corresponding to the non-pathological portions of the morbid state of the bone, and does not include points corresponding to the pathological portions of the morbid state of the bone. As an example, planning system 118 may remove the portions identified as pathological portions in the first point cloud 128. The result may be intermediate point cloud 130. That is, planning system 118 may generate intermediate point cloud 130 (e.g., a second point cloud) that includes points corresponding to the non-pathological portions of the morbid state of the bone, and does not include points corresponding to the pathological portions of the morbid state of the bone (e.g., by having the pathological portions of the first point cloud 128 removed).

In one or more examples, planning system 118 may generate, based on intermediate point cloud 130 (e.g., as second point cloud), a third point cloud representing a pre-morbid state of the bone. For example, the third point cloud may represent pre-morbid bone before the disease or trauma. The third point cloud representing the pre-morbid state of the bone is pre-morbid point cloud 132.

In one or more techniques of this disclosure, to generate intermediate point cloud 130 and/or pre-morbid point cloud 132, planning system 118 may apply a point cloud neural network (PCNN). For example, point cloud 128 (e.g., a first point cloud) may be the input point cloud. The input point cloud represents a morbid state of one or more bones of the patient, where the one or more bones include pathological and non-pathological portions. Intermediate point cloud 130 (e.g., a second point cloud) may be a first output point cloud. In some examples, planning system 118 may apply a PCNN to point cloud 128 to determine information indicative of at least one of pathological and non-pathological portions, and generate intermediate point cloud 130 that includes points corresponding to the non-pathological portions of the morbid state of the bone, and does not include points corresponding to the pathological portions of the morbid state of the bone. For example, planning system 118 may remove the pathological portions in point cloud 128 to generate intermediate point cloud 130.

As one example, the output from the PCNN that planning system 118 applies to point cloud 128 (e.g., morbid point cloud 128 or first point cloud 128) may be labels for each of the points in point cloud 128. For instance, in morbid point cloud 128 there may be pathological portions and non-pathological portions. The pathological portions of morbid point cloud 128 may be portions of morbid point cloud 128 corresponding to pathological portions of the morbid state of the bone, and the non-pathological portions of morbid point cloud 128 may be portions of morbid point cloud 128 corresponding to non-pathological portions of the morbid state of the bone.

The labels may classify each point in point cloud 128 as being one of a pathological point or a non-pathological point. The pathological point is indicative of being in a pathological portion (e.g., of point cloud 128), and the non-pathological point indicative of being in a non-pathological portion (e.g., of point cloud 128). For instance, planning system 118, by applying the PCNN, may generate labels that indicate pathological and non-pathological portions of point cloud 128.

Planning system 118 may then utilize the labels to determine which points to remove from point cloud 128. For instance, for each point labeled as a pathological point, planning system 118 may remove that point from point cloud 128. For each point labeled as a non-pathological point, planning system 118 may leave that point in point cloud 128. The result of removing points from point cloud 128 is intermediate point cloud 130. For instance, intermediate point cloud 130 may include points corresponding to the non-pathological portions of the morbid state of the bone, and does not include points corresponding to the pathological portions of the morbid state of the bone.

In some examples, planning system 118 may apply a PCNN to intermediate point cloud 130 to generate pre-morbid point cloud 132. In this example, pre-morbid point cloud 132 may be the output point cloud that includes points indicating the characteristics (e.g., size, shape, etc.) of the morbid bone before the disease or damage. That is, planning system 118 may generate, based on intermediate point cloud 130, pre-morbid point cloud 132 (e.g., a third point cloud) representing a pre-morbid state of the bone.

In the example of FIG. 1A, system 100A includes a manufacturing system 140. Manufacturing system 100A may manufacture a patient-specific tool alignment guide configured to guide a tool in a target bone of the patient along the tool alignment. Inclusion of manufacturing system 140 is merely one example and should not be considered limiting. In some examples, manufacturing system 140 may manufacture the tool alignment guide based on a representation of the pre-morbid anatomy. For example, planning system 118 may utilize pre-morbid point cloud 132 to generate a graphical representation of the pre-morbid bone or generate information indicative of size and dimensions of the pre-morbid bone. Manufacturing system 140 may utilize such information manufacture the desired tool or tool alignment guide.

Manufacturing system 140 may comprise an additive manufacturing device (e.g., a 3D printer) configured to generate a patient-specific tool alignment guide. In an example where the tool alignment corresponds to a cutting plane of an oscillating saw, the patient-specific tool alignment guide may define a slot for an oscillating saw. When the patient-specific tool alignment guide is correctly positioned on a bone of the patient, the slot is aligned with the determined tool alignment. Thus, a surgeon may use the oscillating saw with the determined tool alignment by inserting the oscillating saw into the slot of the patient-specific tool alignment guide. In an example where the tool alignment corresponds to a drilling axis or pin insertion axis, the patient-specific tool alignment guide may define a channel for a drill bit or pin. When the patient-specific tool alignment guide is correctly positioned on a bone of the patient, the channel is aligned with the determined tool alignment. Thus, a surgeon may drill a hole or insert a pin by inserting a drill bit or pin into the channel of the patient-specific tool alignment guide.

FIG. 1B is a block diagram illustrating another example system 100B that may be used to implement the techniques of this disclosure. The various components in FIG. 1B having the same reference numeral as in FIG. 1A may be considered as being the same or substantially the same, and are not described further with respect to FIG. 1B.

System 100B, in FIG. 1B, includes surgical plans 120B. Surgical plans 120B may be surgical plans for revision surgery. As described above, revision surgery is the surgery when a current prosthetic is removed and replaced with another prosthetic. There may be various reasons for revision surgery including change in disease state, shifting of the prosthetic, reaching practical lifetime of the prosthetic, etc. In some examples, planning system 118 may be configured to generate a representation of the damaged or diseased bone at the time of the initial surgery when the prosthetic was implanted. That is, rather than or in addition to generating a representation of the pre-morbid bone, planning system 118 may be configured to determine a representation of the morbid bone at the time of the initial surgery when the prosthetic was implanted.

As illustrated, surgical plans 120B includes point cloud 142. One example of point cloud 142 may be a point cloud representing anatomy of a patient (e.g., current anatomy of the patient) having a prosthetic that was implanted during an initial surgery. Planning system 118 may obtain point cloud 142 similar to ways in which planning system 118 obtained point cloud 128.

Planning system 118 may generate pre-surgical point cloud 144 representing anatomy of the patient at a time of the initial surgery. For example, planning system 118 may apply a PCNN to point cloud 142 to generate pre-surgical point cloud 144.

For revision surgery, there is already a prosthetic that is implanted. Accordingly, in some examples, point cloud 142 may include representation of the prosthetic. In one or more examples, planning system 118 may be configured to generate pre-surgical point cloud 144 without utilizing portions in point cloud 142 that include the prosthetic.

There may be various ways in which planning system 118 may determine the portions in point cloud 142 that include the prosthetic. As one example, the prosthetic may appear as relatively high luminance image content in medical image data 126. Planning system 118 may remove image content having a luminance higher than a threshold value, and generate point cloud 142 based on the resulting image data. As another example, it may be possible for planning system 118 to utilize another PCNN that is trained to differentiate between the prosthetic and bone. Planning system 118 may remove the portions identified as prosthetic by this PCNN to generate point cloud 142.

The revision surgery may be performed for various bone parts where a prosthetic can be implanted. For instance, the prosthetic may be for one of a tibia, fibula, scapula, humeral head, femur, patella, vertebra, ilium, and so on.

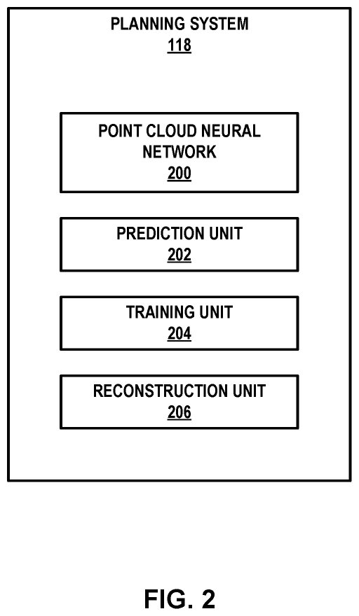

FIG. 2 is a block diagram illustrating example components of planning system 118, in accordance with one or more techniques of this disclosure. In the example of FIG. 2, the components of planning system 118 include a PCNN 200, a prediction unit 202, a training unit 204, and a reconstruction unit 206. In other examples, planning system 118 may be implemented using more, fewer, or different components. For instance, training unit 204 may be omitted in instances where PCNN 200 has already been trained. In some examples, one or more of the components of planning system 118 are implemented as software modules. Moreover, the components of FIG. 2 are provided as examples and planning system 118 may be implemented in other ways.

There may be different examples of PCNN 200. For instance, as described above, in some examples, planning system 118 may apply a PCNN to point cloud 128 to generate information indicative of at least one of pathological portions or non-pathological portions in point cloud 128. A first example of PCNN 200, or simply referred to as a first PCNN 200, may be trained to identify at least one of the pathological portions or the non-pathological portions.

In some examples, planning system 118 may apply a PCNN to intermediate point cloud 130 to generate a point cloud representing a pre-morbid state of the bone (e.g., to generate pre-morbid point cloud 132). A second example of PCNN 200, or simply referred to as a second PCNN 200, may be trained to generate pre-morbid point cloud 132 based on intermediate point cloud 130.

For instance, the second PCNN 200 may be configured to determine a non-pathological estimation of the pathological portions of the morbid state of the bone, and combine the non-pathological estimation of the pathological portions and intermediate point cloud 130 to generate pre-morbid point cloud 132. For instance, to combine the non-pathological estimation of the pathological portions and intermediate point cloud 130, the second PCNN may fill in intermediate point cloud 130 with the non-pathological estimation of the pathological portions.

As described above, the non-pathological estimation of the pathological portions refers to an estimation of non-pathological anatomy (e.g., bone) that fills in the pathological portion that was removed from morbid point cloud 128 to generate intermediate point cloud 130. For instance, the non-pathological estimation of the pathological portions completes the intermediate point cloud 130 so that there are no longer gaps in intermediate point cloud 130 from the removal of the pathological portions. In one or more examples, the non-pathological estimation is referred to as an “estimation” because the second PCNN 200 may be configured to fill in the pathological portions with what the second PCNN 200 determined as being a representation of the pathological portion, but with non-pathological anatomy (e.g., non-pathological bone). An estimation of the non-pathological bone may be all that is available because the bone has been damaged, and there may not be image data of bone prior to the damage.

The second PCNN determining the non-pathological estimation of the pathological portions, and filling in intermediate point cloud 130 are provided as example techniques. In some examples, the second PCNN may be configured to determine pre-morbid point cloud 132 directly from intermediate point cloud 130.

For revision surgery, planning system 118 may apply a PCNN to point cloud 142 to generate pre-surgical point cloud 144. A third example of PCNN 200, or simply referred to as a third PCNN 200, may be trained to determine characteristics of a pre-surgical anatomy where the input is a point cloud representing anatomy of a patient having a prosthetic that was implanted during an initial surgery.

The example techniques do not require the utilization of both the first PCNN 200 and the second PCNN 200. In some examples, planning system 118 may utilize the first PCNN 200, and not the second PCNN 200. In some examples, planning system 118 may utilize the second PCNN 200, and not the first PCNN 200. In some examples, planning system 118 may utilize both the first PCNN 200 and the second PCNN 200. In some examples, the use of the third PCNN (e.g., revision surgery) is not necessary, and planning system 118 may utilize some other technique for generating pre-surgical point cloud 144 (e.g., a point cloud representing the anatomy of the patient at a time of the initial surgery).

Prediction unit 202 may apply PCNN 200 to generate an output point cloud based on an input point cloud. For the first PCNN 200, the input point cloud (e.g., point cloud 128) represents one or more bones of a patient (e.g., morbid bones), and the output point cloud (e.g., intermediate point cloud 130) includes points of point cloud 128 but with the pathological portions removed. That is, intermediate point cloud 130 includes points corresponding to the non-pathological portions of the morbid state of the bone, and does not include points corresponding to the pathological portions of the morbid state of the bone. In some examples, the output point cloud of the first PCNN 200 may be considered as point cloud 128 with labels for each point that indicates whether the point is a pathological point or a non-pathological point, and then planning system 118 removes the pathological points from this output point cloud to generate intermediate point cloud 130. For ease of description only, in some examples, the output point cloud for the first PCNN 200 is described as being intermediate point cloud 130, with the understanding that in some examples, there may be an earlier output point cloud with labels indicating whether a point in point cloud 128 is a pathological point or a non-pathological point, and then the pathological points are removed to generate intermediate point cloud 130.

Prediction unit 202 may obtain point cloud 128 in one of a variety of ways. For example, prediction unit 202 may generate point cloud 128 based on medical image data 126. The medical image data for the patient may include a plurality of input images (e.g., CT images or MRI images, etc.). In this example, each of the input images may have a width dimension and a height dimension, and each of the input images may correspond to a different depth-dimension layer in a plurality of depth-dimension layers. In other words, the plurality of input images may be conceptualized as a stack of 2D images, where the positions of individual 2D images in the stack correspond to the depth dimension. As part of generating point cloud 128, prediction unit 202 may perform an edge detection algorithm (e.g., Canny edge detection, Phase Stretch Transform (PST), etc.) on the 2D images (or a 3D image based on the 2D images).

Prediction unit 202 may select points on the detected edges as points in the point cloud. In other examples, prediction unit 202 may obtain point cloud 128 from one or devices outside of computing system 102. In some examples, such as for use of the second PCNN 200, prediction unit 202 may receive intermediate point cloud 130 from components within planning system 118.

As indicated above, the output point cloud (e.g., intermediate point cloud 130 for the first PCNN 200) may include non-pathological points of point cloud 128, and exclude the pathological points of point cloud 128. As one example, planning system 118 may utilize information indicative of pathological and non-pathological portions generated by the first PCNN 200, and remove the pathological portions to generate intermediate point cloud 130.

The output point cloud (e.g., pre-morbid point cloud 132 for the second PCNN 200) may represent the pre-morbid bone. The representation of the pre-morbid bone may be the bone as it appeared prior to the disease or trauma, and may be considered as the combination of the non-pathological portions of the bone, as included in intermediate point cloud 130, and a non-pathological estimation of the pathological portions (e.g., what the pathological portions appeared like before disease or trauma). For instance, the output point cloud from second PCNN 200 may be intermediate point cloud 130, where the removed pathological portions, are filled in with a non-pathological estimation of the removed pathological portions. However, such filling in with the non-pathological estimation should not be considered limiting, and it may be possible for generate pre-morbid point cloud 132 directly from intermediate point cloud 130.

For revision surgery, prediction unit 202 may obtain point cloud 142 similar to the description above for point cloud 128. The output point cloud (e.g., pre-surgical point cloud 144 for the third PCNN 200) may represent the pre-surgical bone (e.g., the bone of the patient having the prosthetic that was implanted during the initial surgery at the time of the initial surgery).

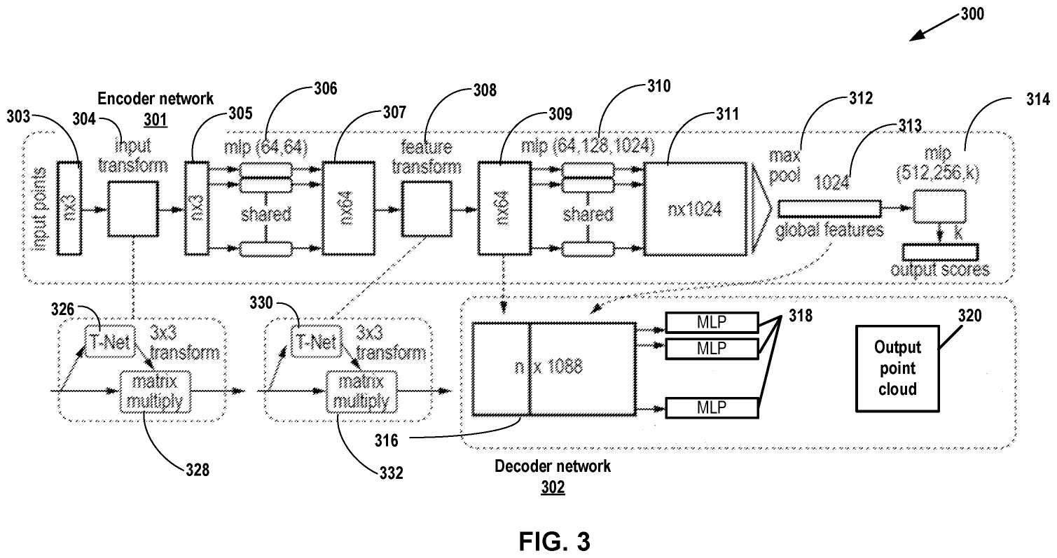

The first PCNN 200, the second PCNN 200, and the third PCNN are implemented using a point cloud learning model-based architecture. A point cloud learning model-based architecture (e.g., a point cloud learning model) is a neural network-based architecture that receives one or more point clouds as input and generates one or more point clouds as output. Example point cloud learning models include PointNet, PointTransformer, and so on. An example point cloud learning model-based architecture based on PointNet is described below with respect to FIG. 3.

As described above, in some examples, there may be a first PCNN 200, a second PCNN 200, and a third PCN 200. In some examples, there may be different sets of the first PCNN 200 and the second PCNN 200, such as based on for which bone a pre-morbid characterization is needed. Similarly, there may be different sets of the third PCNN 20 based on for which bone there is revision surgery.

For example, the set of PCNNs for a total ankle replacement surgery may include a first PCNN and a second PCNN 200 for ankle surgery that generates an output point cloud that includes points indicating the pre-morbid ankle. Similarly, there may be a first PCNN and a second PCNN 200 for surgery of the tibia, fibula, scapula and humeral head (e.g., shoulder), vertebra, patella (e.g., knee), or iliac crest, ilium, ischial spine, coccyx (e.g., a hip). For revision surgery, there may be a set of third PCNN 200 for replacing prosthetic in the ankle, and another set of third PCNN 200 for replacing prosthetic in the shoulder. In general, the prosthetic may be for a tibia, fibula, scapula, humeral head, femur, patella, vertebra, or ilium, but the techniques are not so limited.

Training unit 204 may train PCNN 200. For instance, training unit 204 may generate a groups of training datasets. A first group of training sets may be for training the first PCNN 200. A second group of training sets may be for training the second PCNN 200. A third group of training sets may be for training the third PCNN 200.

Each of the training datasets may correspond to a different historic patient in a plurality of historic patients. The historic patients may include patients having morbid bones and include patients having non-morbid bones.

The training dataset for a historic patient may include training input data and expected output data. For the first PCNN 200 (e.g., for generating information indicative of at least one of pathological portions or non-pathological portions in point cloud 128), the training input data may include a point cloud representing a morbid state of a bone, and the expected output data may include labels for each of the points in point cloud 128 that indicates whether a point is a pathological point belonging to a pathological portion or a non-pathological point belonging to a non-pathological portion.

For the second PCNN 200 for generating pre-morbid point cloud 132 (e.g., such as by combining a non-pathological estimation of the pathological portions with intermediate point cloud 130), the training input data may include a point cloud representing a subset of points of a non-morbid bone, and the expected output data may be the non-morbid bone. For the third PCNN 200 (e.g., for revision surgery), the training input data may include a point cloud of patients determined to have revision surgery, and the expected output data may be the bone at the time of the initial surgery when the prosthetic was implanted.

In some examples, training unit 204 may generate the training input data based on medical image data stored in surgical plans of historic patients. In some examples, training unit 204, for the first PCNN 200, may generate the expected output data based on information from historical patients of what is determined to be pathological portions and what is determined to be non-pathological portions. For instance, a surgeon may indicate, in point clouds of historical patients, portions that are to be considered as pathological and portions that are to be considered as non-pathological. There may be other ways in which to train the first PCNN 200 for generating information indicative of pathological and non-pathological portions in first point cloud 128.

In some examples, training unit 204, for the second PCNN, may generate the expected output data based on information from historical patients having non-morbid bone. For example, the input may be a non-morbid bone with portions removed from historical patients, or possible other non-patient individuals that volunteer for a study. The expected output data may be a point cloud of the non-morbid bone of these individuals.

In some examples, training unit 204, for the third PCNN, may generate the expected output data based on information from historical patients. For instance, training unit 204 may receive point clouds of historical patients at the time of the initial surgery, and use this historical patient data as the expected output data for patients, where the input is the point clouds of these historical patients at the time when these patients were going to have revision surgery. As another example, training unit 204 may receive information from surgeons of what they determined the pre-surgical bone to look like when given image data of patients having revision surgery.

Training unit 204 may train the first PCNN 200, the second PCNN 200, and the third PCNN 200 based on the respective groups of training datasets. Because training unit 204 generates the training datasets based on how real surgeons actually planned and/or executed surgeries in historic patients or point clouds of non-morbid bone, a surgeon who ultimately uses a recommendation generated by planning system 118 may have confidence that the recommendation is based on how other real surgeons determined pathological and non-pathological portions, or how real-life non-morbid appears, or how real-life pre-surgical anatomy appears.

In some examples, as part of training the first PCNN 200, the second PCNN 200, and the third PCNN, training unit 204 may perform a forward pass on the PCNN 200 using the input point cloud of a training dataset as input to PCNN 200. Training unit 204 may then perform a process that compares the resulting output point cloud generated by PCNN 200 to the corresponding expected output point cloud. In other words, training unit 204 may use a loss function to calculate a loss value based on the output point cloud generated by PCNN 200 and the corresponding expected output point cloud. In some examples, the loss function is targeted at minimizing a difference between the output point cloud generated by PCNN 200 and the corresponding expected output point cloud. Examples of the loss function may include a Chamfer Distance (CD) and the Earth Mover's Distance (EMD). The CD may be given by the average of a first average and a second average. The first average is an average of distances between each point in the output point cloud generated by PCNN 200 and its closest point in the expected output point cloud. The second average is an average of distances between each point in the expected output point cloud and its closest point in the output point cloud generated by PCNN 200. The CD may be defined as:

$${ℒ}_{CD} ( {S}_{1} , {S}_{2} ) = \frac{1}{2} ( \frac{1}{\vert {S}_{1} \vert} {\sum }_{x ∈ {S}_{1}} {min}_{y ∈ {S}_{2}} ‖ x - y ‖ + \frac{1}{\vert {S}_{2} \vert} {\sum }_{y ∈ {S}_{2}} {min}_{x ∈ {S}_{1}} ‖ x - y ‖ )$$

In the equation above, S₁ is the output point cloud generated by PCNN 200, S₂ is the expected output point cloud, | . . . | is an element indicating number of elements, and ∥ . . . ∥ indicates absolute value.

For example, for the first PCNN 200, S₁ may be intermediate point cloud 130 or may be a point cloud with labels of points indicating whether a point a pathological point or a non-pathological point. S₂ may be the expected point cloud that was determined from surgeons or other ways. For the second PCNN 200, S₁ may be pre-morbid point cloud 132. S₂ may be the expected point cloud for the pre-morbid bone. For the third PCNN 200, S₁ may be pre-surgical point cloud 144. S₂ may be the expected point cloud for the representation of the bone at the time of the initial surgery.

Training unit 204 may then perform a backpropagation process based on the loss value to adjust parameters of PCNN 200 (e.g., weights of neurons of PCNN 200). In some examples, training unit 204 may determine an average loss value based on loss values calculated from output point clouds generated by performing multiple forward passes through PCNN 200 using different input point clouds of the training data. In such examples, training unit 204 may perform the backpropagation process using the average loss value to adjust the parameters of PCNN 200. Training unit 204 may repeat this process during multiple training epochs.

During use of PCNN 200 (e.g., after training of PCNN 200), prediction unit 202 of planning system 118 may apply PCNN 200 to generate an output point cloud for a patient based on an input point cloud representing one or more bones of the patient. In some examples, reconstruction unit 206 may be configured to use point cloud 132 and generate one or more images of the pre-morbid bone (e.g., a reconstructed version of the morbid bone), or generate information such as size and dimension of the pre-morbid bone. In some examples, reconstruction unit 206 may be configured to use pre-surgical point cloud 144 and generate one or more image of the bone at the time of the initial surgery.

In some examples, reconstruction unit 206 may output for display one or more images (e.g., one or more 2D or 3D images) or models showing the pre-morbid bone. As one example, reconstruction unit 206 may use the points in pre-morbid point cloud 132 or pre-surgical point cloud 144 as vertices of polygons, where the polygons form a hull of the pre-morbid bone). Reconstruction unit 206 may output for display an image showing pre-morbid bone relative to models of the one or more morbid bones of the patient or display an image showing bone at the time of initial surgery when prosthetic was implanted. In some such examples, the output point cloud (e.g., pre-morbid point cloud 132 or pre-surgical point cloud 144) generated by PCNN 200 and the input point cloud (e.g., point cloud 128 or point cloud 142) are in the same coordinate system.

In some examples, reconstruction unit 206 may generate, based on pre-morbid point cloud 132, a MR visualization indicating pre-morbid bone. For revision surgery, reconstruction unit 206 may generate, based on pre-surgical point cloud 144, a MR visualization indicating bone at the time of initial surgery. In examples where visualization device 114 (FIGS. 1A and 1B) is an MR visualization device, visualization device 114 may display the MR visualization. In some examples, visualization device 114 may display the MR visualization during a planning phase of a surgery. In such examples, reconstruction unit 206 may generate the MR visualization as a 3D image in space. Reconstruction unit 206 may generate the 3D image in the same as described above for generating the 3D image.

In some examples, the MR visualization is an intra-operative MR visualization. In other words, visualization device 114 may display the MR visualization during surgery. In some examples, visualization device 114 may perform a registration process that registers the MR visualization with the physical bones of the patient. Accordingly, in such examples, a surgeon wearing visualization device 114 may be able to see the pre-morbid bone relative to a morbid bone of the patient, or for revision surgery, see the bone at the time of the initial surgery relative to the current bone of the patient.

FIG. 3 is a conceptual diagram illustrating an example point cloud learning model 300 in accordance with one or more techniques of this disclosure. Point cloud learning model 300 may receive an input point cloud. The input point cloud is a collection of points. The points in the collection of points are not necessarily arranged in any specific order. Thus, the input point cloud may have an unstructured representation.

In the example of FIG. 3, point cloud learning model 300 includes an encoder network 301 and a decoder network 302. Encoder network 301 receives an array 303 of n points. The points in array 303 may be the input point cloud of point cloud learning model 300. In the example of FIG. 3, each of the points in array 303 has a dimensionality of 3. For instance, in a Cartesian coordinate system, each of the points may have an x coordinate, ay coordinate, and a Z coordinate.

Encoder network 301 may apply an input transform 304 to the points in array 303 to generate an array 305. Encoder network 301 may then use a first shared multi-layer perceptron (MLP) 306 to map each of the n points in array 305 from three dimensions to a larger number of dimensions a (e.g., a=64 in the example of FIG. 3), thereby generating an array 307 of n×a (e.g., n×64 values). For ease of explanation, the following description of FIG. 3 assumes that a is equal to 64 but in other examples other values of a may be used. Encoder network 301 may then apply a feature transform 308 to the values in array 307 to generate an array 309 of n×64 values. For each of the n points in array 309, encoder network 301 uses a second shared MLP 310 to map the n points from a dimension to b dimensions (e.g., b=1024 in the example of FIG. 3), thereby generating an array 311 of n×b (e.g., n×1024 values). For ease of explanation, the following description of FIG. 3 assumes that b is equal to 1024 but in other examples other values of b may be used. Encoder network 301 applies a max pooling layer 312 to generate a global feature vector 313. In the example of FIG. 3, each of points n in global feature vector 313 has 1024 dimensions.

Thus, as part of applying an PCNN 200, computing system 102 may apply an input transform (e.g., input transform 304) to a first array (e.g., array 303) that comprises the point cloud to generate a second array (e.g., array 305), wherein the input transform is implemented using a first T-Net model (e.g., T-Net Model 326), apply a first MLP (e.g., MLP 306) to the second array to generate a third array (e.g., array 307), apply a feature transform (e.g., feature transform 308) to the third array to generate a fourth array (e.g., array 309), wherein the input transform is implemented using a second T-Net model (e.g., T-Net model 330), apply a second MLP (e.g., MLP 310) to the fourth array to generate a fifth array (e.g., array 311), and apply a max pooling layer (e.g., max pooling layer 312) to the fifth array to generate the global feature vector (e.g., global feature vector 313).

A fully-connected network 314 may map global feature vector 313 to k output classification scores. The value k is an integer indicating a number of classes. Each of the output classification scores corresponds to a different class. An output classification score corresponding to a class may indicate a level of confidence that the input point cloud as a whole corresponds to the class. Fully-connected network 314 includes a neural network having two or more layers of neurons in which each neuron in a layer is connected to each neuron in a subsequent layer. In the example of FIG. 3, fully-connected network 314 includes an input layer having 512 neurons, a middle layer having 256 neurons, and an output layer having k neurons. In some examples, fully-connected network 314 may be omitted from encoder network 301.

In some examples, input 316 to decoder network 302 may be formed by concatenating the n 64-dimensional points of array 309 with global feature vector 313. In other words, for each point of the n points in array 309, the corresponding 64 dimensions of the point are concatenated with the 1024 features in global feature vector 313. In some examples, array 309 is not concatenated with global feature vector 313. Decoder network 302 may sample N points in a unit square in 2-dimensions.

Thus, decoder network 302 may randomly determine N points having x-coordinates in a range of [0,1] and y-coordinates in the range of [0,1]. For each respective point of the N points, decoder network 302 may obtain a respective input vector by concatenating the respective point with global feature vector 313. Thus, in examples where array 309 is not concatenated with global feature vector 313, each of the input vectors may have 1026 features. For each respective input vector, decoder network 302 may apply each of K MLPs 318 (where K is an integer greater than or equal to 1) to the respective input vector. Each of MLPs 318 may correspond to a different patch (e.g., area) of the output point cloud. When decoder 302 applies the MLP to an input vector, the MLP may generate a 3-dimensional point in the patch (e.g., area) corresponding to the MLP. Thus, each of the MLPs 318 may reduce the number of features from 1026 to 3. The 3 features may correspond to the 3 coordinates of a point of the output point cloud. For instance, for each sampled point n in N, the MLPs 318 may reduce the features from 1026 to 512 to 256 to 128 to 64 to 3. Thus, decoder network 302 may generate a K×N×3 vector containing an output point cloud 320. In some examples, K=16 and N=512, resulting in second point cloud with 8192 3D points. In other examples, other values of K and N may be used. In some examples, as part of training the MLPs of decoder network 302, decoder network 302 may calculate a chamfer loss of an output point cloud relative to a ground-truth point cloud. Decoder network 302 may use the chamfer loss in a backpropagation process to adjust parameters of the MLPs. In this way, planning system 118 may apply the decoder (e.g., decoder network 302) to generate intermediate point cloud 130 and pre-morbid point cloud 132, for the example of FIG. 1A, or pre-surgical point cloud 144, for the example of FIG. 1B.

In some examples, MLPs 318 may include a series of four fully-connected layers of neurons. For each of MLPs 318, decoder network 302 may pass an input vector of 1026 features to an input layer of the MLP. The fully-connected layers may reduce to number of features from 1026 to 512 to 256 to 3.

Input transform 304 and feature transform 308 in encoder network 301 may provide transformation invariance. In other words, point cloud learning model 300 may be able to generate output point clouds (e.g., intermediate point cloud 130, pre-morbid point cloud 132, and/or pre-surgical point cloud 144) in the same way, regardless of how the input point cloud (e.g., input bone model) is rotated, scaled, or translated. The fact that point cloud learning model 300 provides transform invariance may be advantageous because it may reduce the susceptibility of a generator ML model to errors based on positioning/scaling in morbid bone models. As shown in the example of FIG. 3, input transform 304 may be implemented using a T-Net Model 326 and a matrix multiplication operation 328. T-Net Model 326 generates a 3×3 transform matrix based on array 303. Matrix multiplication operation 328 multiplies array 303 by the 3×3 transform matrix. Similarly, feature transform 308 may be implemented using a T-Net model 330 and a matrix multiplication operation 332. T-Net model 330 may generate a 64×64 transform matrix based on array 307. Matrix multiplication operation 328 multiplies array 307 by the 64×64 transform matrix.

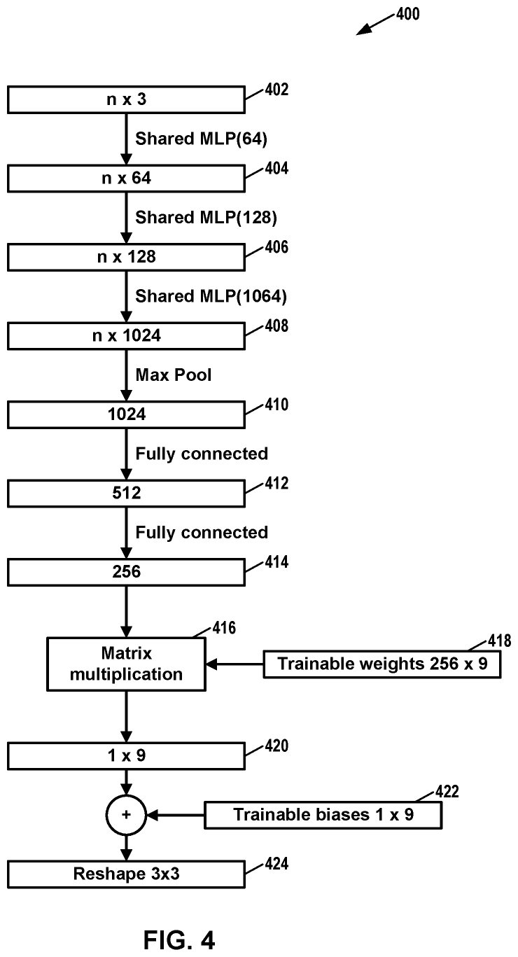

FIG. 4 is a block diagram illustrating an example architecture of a T-Net model 400 in accordance with one or more techniques of this disclosure. T-Net model 400 may implement T-Net Model 326 used in the input transform 304. In the example of FIG. 4, T-Net model 400 receives an array 402 as input. Array 402 includes n points. Each of the points has a dimensionality of 3. A first shared MLP maps each of the n points in array 402 from 3 dimensions to 64 dimensions, thereby generating an array 404. A second shared MLP maps each of the n points in array 404 from 64 dimensions to 128 dimensions, thereby generating an array 406. A third shared MLP maps each of the n points in array 406 from 128 dimensions to 1024 dimensions, thereby generating an array 408. T-Net model 400 then applies a max pooling operation to array 408, resulting in an array 810 of 1024 values. A first fully-connected neural network maps array 410 to an array 812 of 512 values. A second fully-connected neural network maps array 412 to an array 414 of 256 values. T-Net model 400 applies a matrix multiplication operation 416 to a matrix of trainable weights 418. The matrix of trainable weights 418 has dimensions of 256×9. Thus, multiplying array 414 by the matrix of trainable weights 418 results in an array 820 of size 1×9. T-Net model 400 may then add trainable biases 422 to the values in array 420. A reshaping operation 424 may remap the values resulting from adding trainable biases 422 into a 3×3 transform matrix. In other examples, the sizes of the matrixes and arrays may be different.

T-Net model 330 (FIG. 3) may be implemented in a similar way as T-Net model 400 in order to perform feature transform 308. However, in this example, the matrix of trainable weights 418 is 256×4096 and the trainable biases 422 has size 1×4096 bias values instead of 9. Thus, the T-Net model for performing feature transform 308 may generate a transform matrix of size 64×64. In other examples, the sizes of the matrixes and arrays may be different.

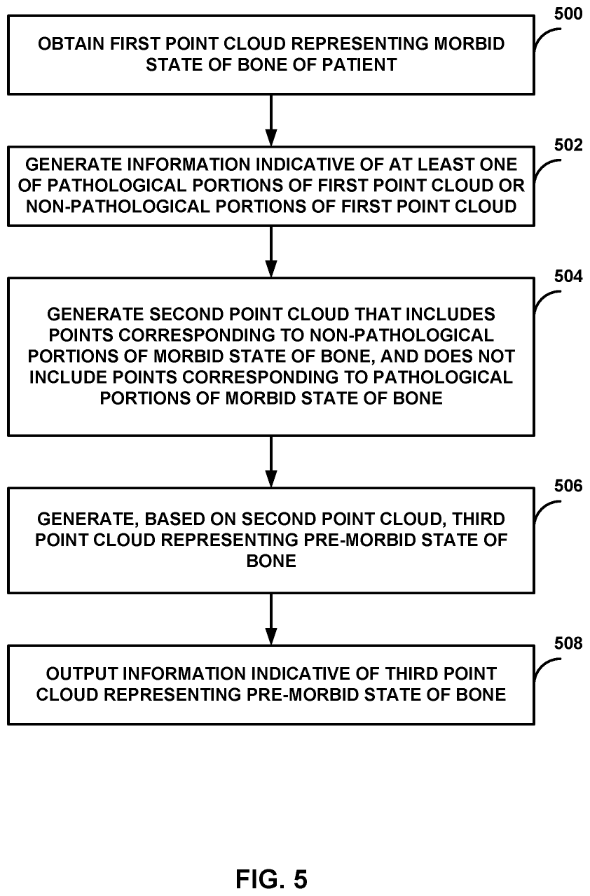

FIG. 5 is a flowchart illustrating an example process for pre-morbid characterization of patient anatomy in accordance with one or more techniques of this disclosure. Computing system 102 (e.g., processing circuitry 104 implementing planning system 18) may obtain a first point cloud representing a morbid state of a bone of a patient (500). For example, the first point cloud may be point cloud 128. As described above, computing system 102 may utilize medical image data 126 to generate point cloud 128. Point cloud 128 may include morbid anatomy, such as one or more bones. Examples of the bone includes at least one of a tibia, fibula, scapula, humeral head, femur, patella, vertebra, iliac crest, ilium, ischial spine, or coccyx.

Computing system 102 may generate information indicative of at least one of pathological portions of the first point cloud or non-pathological portions of the first point cloud (502). The pathological portions of the first point cloud (e.g., point cloud 128) may be portions of the first point cloud corresponding to pathological portions of the morbid state of the bone, and the non-pathological portions of the first point cloud may be portions of the first point cloud corresponding to non-pathological portions of the morbid state of the bone. For example, computing system 102 may generate information indicative of at least one of pathological portions or non-pathological portions in the first point cloud by applying a PCNN (e.g., a first PCNN 200) to the first point cloud. For instance, first PCNN may be trained to identify at least one of the pathological portions or the non-pathological portions.

In some examples, to generate information indicative of at least one of pathological portions or non-pathological portions in the first point cloud, computing system 102 may label each point in the first point cloud as being one of a pathological point or a non-pathological point based on applying the first PCNN to the first point cloud. In one or more examples, the pathological point is indicative of being in a pathological portion, and the non-pathological point is indicative of being in a non-pathological portion.

Also, in some examples, the first point cloud (e.g., point cloud 128) need not necessarily include all of the morbid bone. For example, the first point cloud may represent a point cloud of a morbid tibia, where a distal end, near an ankle, of the tibia is removed from point cloud 128 of the morbid tibia. In such examples, to generate information indicative of at least one of pathological portions of the first point cloud or non-pathological portions of the first point cloud, computing system 102 may be configured to generate information indicative of at least one of pathological portions of the point cloud or non-pathological portions of the point cloud of the morbid tibia having the distal end removed.

The use of the first PCNN may not be necessary in all examples. There may be other ways in which to generate information indicative of at least one of pathological portions and non-pathological portions. For instance, a surgeon may identify pathological portions and non-pathological portions.

As another example, computing system 102 may compare the first point cloud with a statistical shape model (SSM) to generate information indicative of pathological portions and non-pathological portions. For example, for an SSM, computing system 102 may obtain a point cloud of the SSM, where the SSM is a representative model of a pre-morbid state the anatomy. The processing circuitry may orient the point cloud of the SSM or the point cloud representing the morbid state of the anatomy so that the point cloud of the SSM and the point cloud representing the morbid state of the anatomy have the same orientation. Computing system 102 may determine non-pathological points in the point cloud representing the morbid state of the anatomy. For instance, as described above, in the point cloud representing the morbid state of the anatomy, there may be pathological portions and non-pathological portions. Computing system 102 may deform the point cloud of the SSM until the points in the point cloud of the SSM register with the identified non-pathological points. Computing system 102 may determine a difference between the registered SSM and the point cloud representing the morbid state of the anatomy. The result of the difference may be the pathological portions.

Computing system 102 may generate a second point cloud that includes points corresponding to the non-pathological portions of the morbid state of the bone, and does not include points corresponding to the pathological portions of the morbid state of the bone (504). For example, computing system 102 may generate the second point cloud having the pathological portions (e.g., of the first point cloud) removed. One example of the second point cloud is intermediate point cloud 130. As one example, computing system 102 may utilize the labels that indicate pathological points and non-pathological points in point cloud 128. Computing system 102 may remove points in point cloud 128 labeled as pathological points, and keep in place points in point cloud 128 labeled as non-pathological points. The result of removing the pathological points may be intermediate point cloud 130 that includes points corresponding to the non-pathological portions of the morbid state of the bone, and does not include points corresponding to the pathological portions of the morbid state of the bone.

Computing system 102 may generate, based on the second point cloud, a third point cloud representing the pre-morbid state of the bone (506). As one example, computing system 102 may apply a second PCNN configured to directly generate the third point cloud based on the second point cloud.

As another example, to generate the third point cloud based on the second point cloud, computing system 102 may determine, with the second PCNN, a non-pathological estimation of the pathological portions of the morbid state of the bone, and combine the non-pathological estimation of the pathological portions and the second point cloud to generate the third point cloud. For instance, with the second PCNN, to combine the non-pathological estimation of the pathological portions and the second point cloud, computing system 102 may fill in the second point cloud with the non-pathological estimation of the pathological portions.

As described above, the non-pathological estimation of the pathological portions refers to an estimation of non-pathological anatomy (e.g., bone) that fills in the pathological portion that is removed from the first point cloud to generate the second point cloud. Stated another way, the non-pathological estimation of the pathological portions completes the point cloud so that there are no longer gaps in the point cloud from the removal of the pathological portions. The completion of the point cloud with an estimation of non-pathology anatomy results in a reconstruction of the morbid bone, which is a pre-morbid characterization of the morbid bone.

As another example, to generate the third point cloud based on the second point cloud, computing system 102 may utilize an SSM. For instance, computing system 102 may utilize a PCNN to identify at least one of the pathological portions or the non-pathological portions, and then remove the pathological portions, as described above. Computing system 102 may utilize non-pathological portions to drive the fitting of an SSM represented in point cloud. For instance, computing system 102 may orient the non-pathological portions to have the same orientation as the SSM. Computing system 102 may deform the point cloud of the SSM (e.g., stretch, shrink, rotate, translate, etc.) until the points in the point cloud of the SSM register with the identified non-pathological points. That is, computing system 102 may determine a first deformed SSM (e.g., by stretching, shrinking, rotating, translating, etc.), and determine distances between corresponding points in the first deformed SSM and the points of the non-pathological portion. Computing system 102 may repeat such operations for different deformed SSMs. Computing system 102 may identify the version of the SSM that registers with the identified non-pathological points (e.g., the version of the SSM having points that best match corresponding points of the non-pathological points). The resulting version of the SSM may be third point cloud representing the pre-morbid state of the bone.

Computing system 102 may output information indicative of the third point cloud representing the pre-morbid state of the bone (508). As one example, reconstruction unit 206 may generate a graphical representation of pre-morbid point cloud 132 that the surgeon can view with visualization device 114, as one example.

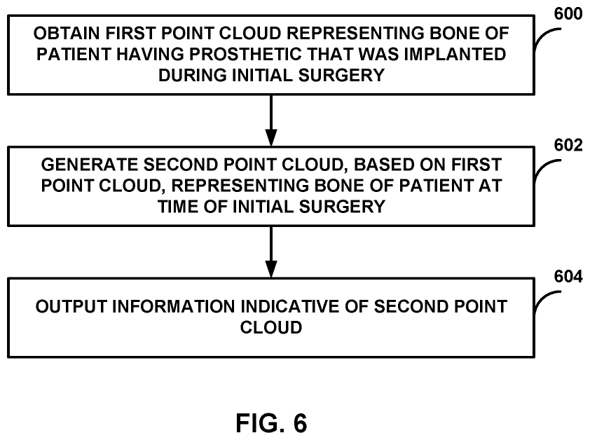

FIG. 6 is a flowchart illustrating an example process for pre-surgical characterization of patient anatomy for revision surgery. Computing system 102 (e.g., processing circuitry 104 implementing planning system 118) may obtain a first point cloud representing bone of a patient having a prosthetic that was implanted during an initial surgery (600). For example, for revision surgery, there may be instances where the current prosthetic is replaced, and therefore, computing system 102 may obtain point cloud 142 that represents anatomy of the patient having the prosthetic. In some examples, the prosthetic is for one of a tibia, fibula, scapula, humeral head, femur, patella, vertebra, or ilium.

Computing system 102 may generate a second point cloud, based on the first point cloud, representing the anatomy of the patient at a time of the initial surgery (602). For example, computing system 102 may generate pre-surgical point cloud 144 by applying a third PCNN (e.g., as described above with respect to FIG. 2) to point cloud 142. In some examples, computing system 102 may generate pre-surgical point cloud 144 without utilizing portions in point cloud 142 that include the prosthetic.

Computing system 102 may output information indicative of the second point cloud (604). As one example, reconstruction unit 206 may generate a graphical representation of pre-surgical point cloud 144 that the surgeon can view with visualization device 114, as one example.

While the techniques been disclosed with respect to a limited number of examples, those skilled in the art, having the benefit of this disclosure, will appreciate numerous modifications and variations there from. For instance, it is contemplated that any reasonable combination of the described examples may be performed. It is intended that the appended claims cover such modifications and variations as fall within the true spirit and scope of the invention.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Operations described in this disclosure may be performed by one or more processors, which may be implemented as fixed-function processing circuits, programmable circuits, or combinations thereof, such as one or more digital signal processors (DSPs), general purpose microprocessors, application specific integrated circuits (ASICs), field programmable gate arrays (FPGAs), or other equivalent integrated or discrete logic circuitry. Fixed-function circuits refer to circuits that provide particular functionality and are preset on the operations that can be performed. Programmable circuits refer to circuits that can programmed to perform various tasks and provide flexible functionality in the operations that can be performed. For instance, programmable circuits may execute instructions specified by software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. Accordingly, the terms “processor” and “processing circuitry,” as used herein may refer to any of the foregoing structures or any other structure suitable for implementation of the techniques described herein.

1. A method for pre-morbid characterization of patient anatomy, the method comprising:
obtaining, by a computing system, a first point cloud representing a morbid state of a bone of a patient;
generating, by the computing system, information indicative of at least one of pathological portions of the first point cloud or non-pathological portions of the first point cloud, the pathological portions of the first point cloud being portions of the first point cloud corresponding to pathological portions of the morbid state of the bone, and the non-pathological portions of the first point cloud being portions of the first point cloud corresponding to non-pathological portions of the morbid state of the bone;
generating, by the computing system, a second point cloud that includes points corresponding to the non-pathological portions of the morbid state of the bone, and does not include points corresponding to the pathological portions of the morbid state of the bone;
generating, by the computing system and based on the second point cloud, a third point cloud representing a pre-morbid state of the bone; and
outputting, by the computing system, information indicative of the third point cloud representing the pre-morbid state of the bone.

2. The method of claim 1, wherein generating the third point cloud comprises:
determining a non-pathological estimation of the pathological portions of the morbid state of the bone; and
combining the non-pathological estimation of the pathological portions and the second point cloud to generate the third point cloud.

3. The method of claim 2, wherein combining the non-pathological estimation of the pathological portions and the second point cloud comprises filling in the second point cloud with the non-pathological estimation of the pathological portions.

4. The method of claim 1, wherein generating information indicative of at least one of the pathological portions of the first point cloud or the non-pathological portions of the first point cloud comprises generating information indicative of at least one of pathological portions of the first point cloud or non-pathological portions of the first point cloud based on applying a point cloud neural network (PCNN) to the first point cloud, wherein the PCNN is trained to identify at least one of the pathological portions or the non-pathological portions.

5. The method of claim 1, wherein generating the third point cloud representing the pre-morbid state of the bone comprises generating the third point cloud based on applying a point cloud neural network (PCNN) to the second point cloud.

6. The method of claim 1,
wherein generating information indicative of at least one of the pathological portions of the first point cloud or the non-pathological portions of the first point cloud comprises generating information indicative of at least one of pathological portions of the first point cloud or the non-pathological portions of the first point cloud based on applying a first point cloud neural network (PCNN) to the first point cloud, wherein the first PCNN is trained to identify at least one of the pathological portions or the non-pathological portions; and
wherein generating the third point cloud representing the pre-morbid state of the bone comprises generating the third point cloud based on applying a second PCNN to the second point cloud.

7. The method of claim 1, wherein the bone comprises at least one of a tibia, fibula, scapula, humeral head, femur, patella, vertebra, iliac crest, ilium, ischial spine, or coccyx.

8. The method of claim 1, wherein generating information indicative of at least one of the pathological portions of the first point cloud or the non-pathological portions of the first point cloud comprises labeling each point in the first point cloud as being one of a pathological point or a non-pathological point based on applying a point cloud neural network (PCNN) to the first point cloud, the pathological point indicative of being in a pathological portion, and the non-pathological point indicative of being in a non-pathological portion.

9. The method of claim 1, wherein the first point cloud representing the morbid state of the bone of the patient comprises a point cloud of a morbid tibia, wherein points in the point cloud representing a distal end, near an ankle, of the morbid tibia is removed from the point cloud of the morbid tibia, and wherein generating information indicative of at least one of the pathological portions of the first point cloud or the non-pathological portions of the first point cloud comprises generating information indicative of at least one of pathological portions of the point cloud or non-pathological portions of the point cloud of the morbid tibia having the distal end removed.

10-13. (canceled)

14. A system comprising:
a storage system configured to store a first point cloud representing a morbid state of a bone of a patient; and
processing circuitry configured to:
obtain the first point cloud representing the morbid state of the bone of the patient;
generate information indicative of at least one of pathological portions of the first point cloud or non-pathological portions of the first point cloud, the pathological portions of the first point cloud being portions of the first point cloud corresponding to pathological portions of the morbid state of the bone, and the non-pathological portions of the first point cloud being portions of the first point cloud corresponding to non-pathological portions of the morbid state of the bone;
generate a second point cloud that includes points corresponding to the non-pathological portions of the morbid state of the bone, and does not include points corresponding to the pathological portions of the morbid state of the bone;
generate, based on the second point cloud, a third point cloud representing a pre-morbid state of the bone; and
output information indicative of the third point cloud representing the pre-morbid state of the bone.

15. The system of claim 14, wherein to generate the third point cloud, the processing circuitry is configured to:
determine a non-pathological estimation of the pathological portions of the morbid state of the bone; and
combine the non-pathological estimation of the pathological portions and the second point cloud to generate the third point cloud.

16. The system of claim 15, wherein to combine the non-pathological estimation of the pathological portions and the second point cloud, the processing circuitry is configured to fill in the second point cloud with the non-pathological estimation of the pathological portions.

17. The system of claim 14, wherein to generate information indicative of at least one of the pathological portions of the first point cloud or the non-pathological portions of the first point cloud, the processing circuitry is configured to generate information indicative of at least one of pathological portions of the first point cloud or non-pathological portions of the first point cloud based on applying a point cloud neural network (PCNN) to the first point cloud, wherein the PCNN is trained to identify at least one of the pathological portions or the non-pathological portions.

18. The system of claim 14, wherein to generate the third point cloud representing the pre-morbid state of the bone, the processing circuitry is configured to generate the third point cloud based on applying a point cloud neural network (PCNN) to the second point cloud.

19. The system of claim 14,
wherein to generate information indicative of at least one of the pathological portions of the first point cloud or the non-pathological portions of the first point cloud, the processing circuitry is configured to generate information indicative of at least one of pathological portions of the first point cloud or the non-pathological portions of the first point cloud based on applying a first point cloud neural network (PCNN) to the first point cloud, wherein the first PCNN is trained to identify at least one of the pathological portions or the non-pathological portions; and
wherein to generate the third point cloud representing the pre-morbid state of the bone, the processing circuitry is configured to generate the third point cloud based on applying a second PCNN to the second point cloud.

20. The system of claim 14, wherein the bone comprises at least one of a tibia, fibula, scapula, humeral head, femur, patella, vertebra, iliac crest, ilium, ischial spine, or coccyx.

21. The system of claim 14, wherein to generate information indicative of at least one of the pathological portions of the first point cloud or the non-pathological portions of the first point cloud, the processing circuitry is configured to label each point in the first point cloud as being one of a pathological point or a non-pathological point based on applying a point cloud neural network (PCNN) to the first point cloud, the pathological point indicative of being in a pathological portion, and the non-pathological point indicative of being in a non-pathological portion.

22. The system of claim 14, wherein the first point cloud representing the morbid state of the bone of the patient comprises a point cloud of a morbid tibia, wherein points in the point cloud representing a distal end, near an ankle, of the morbid tibia is removed from the point cloud of the morbid tibia, and wherein to generate information indicative of at least one of the pathological portions of the first point cloud or the non-pathological portions of the first point cloud, the processing circuitry is configured to generate information indicative of at least one of pathological portions of the point cloud or non-pathological portions of the point cloud of the morbid tibia having the distal end removed.

23-27. (canceled)

28. A non-transitory computer-readable storage medium storing instructions thereon that when executed cause one or more processors to;
obtain a first point cloud representing a morbid state of a bone of a patient;
generate information indicative of at least one of pathological portions of the first point cloud or non-pathological portions of the first point cloud, the pathological portions of the first point cloud being portions of the first point cloud corresponding to pathological portions of the morbid state of the bone, and the non-pathological portions of the first point cloud being portions of the first point cloud corresponding to non-pathological portions of the morbid state of the bone;
generate a second point cloud that includes points corresponding to the non-pathological portions of the morbid state of the bone, and does not include points corresponding to the pathological portions of the morbid state of the bone;
generate, based on the second point cloud, a third point cloud representing a pre-morbid state of the bone; and
output information indicative of the third point cloud representing the pre-morbid state of the bone.

29. The non-transitory computer-readable storage medium of claim 28, wherein the instructions that cause the one or more processors to generate information indicative of at least one of the pathological portions of the first point cloud or the non-pathological portions of the first point cloud comprise instructions that cause the one or more processors to generate information indicative of at least one of pathological portions of the first point cloud or non-pathological portions of the first point cloud based on applying a point cloud neural network (PCNN) to the first point cloud, wherein the PCNN is trained to identify at least one of the pathological portions or the non-pathological portions.
